(19) United States
(12) Patent Application Publication
(10) Pub. No.: US 2013/0080536 A1
(43) Pub. Date: Mar. 28, 2013

(54) SYSTEM AND METHOD FOR AN AUTOMATED DATA DISCOVERY SERVICE

(71) Applicants: Jerome Rolia, Kanata (CA); Mark Jacobsen, Galway (IE); Gary Moloney, Galway (IE); Steven J. Simske, Ft. Collins, CO (US)

(72) Inventors: Jerome Rolia, Kanata (CA); Mark Jacobsen, Galway (IE); Gary Moloney, Galway (IE); Steven J. Simske, Ft. Collins, CO (US)

(73) Assignee: HEWLETT-PACKARD DEVELOPMENT COMPANY, L.P., Houston, TX (US)

(21) Appl. No.: 13/702,045

(22) PCT Filed: Jun. 30, 2010
(86) PCT No.: PCT/US2010/040592

§ 371 Date: Dec. 4, 2012

(51) Int. Cl. G06F 17/30; G06F 15/16

(52) U.S. Cl. CPC G06F 17/30; G06F 15/16
USPC 709/204; 709/225

(57) ABSTRACT

The present disclosure includes a system and method for an automated data discovery system [701] in a collaborative information system [222]. One example method includes authorizing, by a number of participants, a query service having specified data inputs and outputs, the query service comprising a group of queries [703]. One or more models are configured, by the number of participants, to constrain the group of queries to restricted portions of a plurality of communicatively coupled participant data sources [709]. An automated data discovery service is to authorized by the number of participants [711], and the discovery service is invoked by the number of participants to execute the group of queries subject to constraints of the configured models to obtain discovered information [713].

### CROSS REFERENCE TO RELATED APPLICATIONS

The present application is related to (1) PCT Application serial number ______, attorney docket number 201000505-1, entitled “System and Method for Service Recommendation Service,” filed on the same date as the present application, (2) PCT Application serial number ______, attorney docket number 201000504-1, entitled “System and Method for Serialized Data Service,” filed on the same date as the present application, (3) PCT Application serial number ______, attorney docket number 201000495-1, entitled “System and Method for Collaborative Information Services,” filed on the same date as the present application, and (4) PCT Application serial number ______, attorney docket number 201000497-1, entitled “System and Method for Self-Service Configuration of Authorization,” filed on the same date as the present application, the disclosures which are incorporated herein by reference.

### BACKGROUND

Information can have great value. Assembling and maintaining a database to store information involves real costs. The costs can include the costs to acquire the information, the costs associated with the physical assets used to house, secure, and make the information available, and/or the labor costs to manage the information.

Some of the value of certain information may be derived from the fact that the information is not widely known (e.g., not shared). For example, a list of suppliers, their products and pricing, or a customer list, may be valuable to a manufacturing entity, which likely would not be inclined to share such information with its competitors. Conversely, some of the value of other information may be derived from the fact that the information is widely known (e.g., shared). For example, a library catalog is information that can be valuable to a community of users by being widely available, thereby saving time, effort, and perhaps money in trying to locate a particular item in a collection of items.

Some competitive information that principally derives value from not being widely known (e.g., among competitors and/or customers) may derive additional value were it shared with other entities in a limited manner. One such example is information related to a supply chain. A supply chain is a system of organizations, people, technology, activities, information and resources involved in moving a product or service from supplier to customer. Relationships of participants in a supply chain may include supplier-customer, and/or competitors, among others. Regulators and/or consumers may also have an interest in information concerning a particular supply chain. For example, information regarding the supply chain of a food product may be of interest to regulators and/or consumers.

It may be beneficial to share information on a limited basis to demonstrate that a certain component is not involved, or otherwise trace items and/or processes involved in the supply chain. It may be desirable to share information on a limited basis for studies that might benefit multiple supply chain entities and/or the consumers, or to prove or disprove some fact to regulators. Increased traceability can also limit the potentially huge economic and safety consequences of counterfeiting and defective products. For example, global food and/or brand name piracy concerns can cost the industry billions of dollars each year, and can cause the industry to implement anti-counterfeit technologies to protect products, brand and/or market. Recall is also a critical service where remedial activities are to applied to a defective product or component thereof, making it desirable to identify locations of the affected product. Increased traceability along a supply chain can increase trust and limit the consequences of events closer to their source in a supply chain, for example, by decreasing the response time and improving response effectiveness.

Discovery can be a big challenge for a collaborative information system. Previous discovery approaches have utilized a discovery infrastructure that may be separate and/or distinct from a query infrastructure, including for example, separate configuration and management programming interfaces. As such, it can be a burden on participants to enable and manage their support for data discovery over time.

### BRIEF DESCRIPTION OF THE DRAWINGS

FIG. 1 is a diagram illustrating a computing system according to an example of the present disclosure.

FIG. 2A is a diagram illustrating an example computing platform for providing collaborative information services according to an example of the present disclosure.

FIG. 2B is a diagram illustrating another example computing platform for providing collaborative information services according to an example of the present disclosure.

FIG. 3 is a diagram illustrating components of the collaborative information services platform according to an example of the present disclosure.

FIG. 4 is a diagram illustrating an authorization and attestation service for a computing platform according to an example of the present disclosure.

FIG. 5 is a diagram illustrating an automated data discovery service for a computing platform according to an example of the present disclosure.

FIG. 6 is a diagram illustrating a cloud index cache arrangement according to an example of the present disclosure.

FIG. 7 is a flow chart illustrating an example of a method for automated data discovery service according to an example of the present disclosure.

### DETAILED DESCRIPTION

The present disclosure includes a system and method for automated data discovery in a collaborative information system. One example method includes authorizing, by a number of participants, a query service having specified data inputs and outputs, the query service comprising a group of queries. One or more models are configured, by the number of participants, to constrain the group of queries to restricted portions of a plurality of communicatively coupled participant data sources. An automated data discovery service is authorized by the number of participants, and the automated data discovery service is invoked by the number of participants to execute the group of queries subject to constraints of the configured models to obtain discovered information.

The collaborative information system of the present disclosure is arranged generally in a hub-and-spokes configuration, with a collaborative information services (CIS) computing platform programmed with query services as a hub, and participant data sources as the spokes. Participants in the collaborative information system make some portion of their respective data sources available to queries of other participants. According to the present disclosure, participants authorize query services with constrained data inputs and known output attributes. A query service is a group of one or more queries executed to ascertain information of interest. A query set is a number of queries that can be related to one another in some aspect. A query service may include queries from one or more query sets, or the queries comprising multiple query services may all be included in a single query set. That is, a query service may be a subset of one or more query sets, or multiple query services may be subsets of a single query set, depending on the queries comprising the query set(s) and the query service(s).

According to the collaborative information system of the present disclosure, attributes of each query service are defined prior to the query service being invoked by any participant. Each data source controlling entity must implement pre-defined queries of a query service to involve their respective data source. For example, the type of data and scope of data sources associated with a particular query service is pre-defined, the attributes of a respective query service being made available to participants so that they can determine whether, and to what extent, to expose their respective data source to the queries of a query service. That is, each query service is implemented using a “canned” group of queries that can be applied to a data source, if authorized by the control entity of the data source and the queries implemented on the respective data source. Similarly, scope, format, etc., of query results are also defined prior to a query service being invoked. Such a pre-defined result may be computed and mutually advantageous for the query invoker and data providers to share. It may obfuscate aspects of the data obtained by the embedded queries to compute intermediate results but that the data providers may not want or need to share directly. This may encourage providers to share more data with the knowledge that those invoking query services only have access to the possibly more limited computed results. Having pre-defined queries in terms of inputs and outputs enables collaborative information system participants to make informed decisions as to the type and extent of queries, and therefore query services, to which they are willing to allow their respective data source to be exposed.

According to the collaborative information system of the present disclosure, information needed for authorized results (e.g., raw data source data, intermediate computations, etc.) may, or may not, be presented to the participant that invokes a particular query service. In some previous approaches, the data being made available by each participant needed to be stored (e.g., duplicated to) a particular dedicated computing system storage media. However, the collaborative information system of the present disclosure does not require participant-contributed information to be maintained in a common, dedicated location. That is, the collaborative information system of the present disclosure enables participants to self-configure various authorization models that in turn control access of other participants to their data source(s). In this manner, dispersed data sources, including cloud based data sources, can be controlled to the degree desired by the data source control entity at their original location.

According to the collaborative information system of the present disclosure, authorization to access data of a data source is made with respect to query services of the collaborative information services computing platform, rather than peer-to-peer with each participant in the collaborative information system. Thus, the collaborative information system of the present disclosure enables self-configuration of authorizations by participants with fewer interventions by their IT staff. Also, automated and repeated discovery of information available from portions of the data sources available to the query services supports the efficient implementation of real time query services on a large scale.

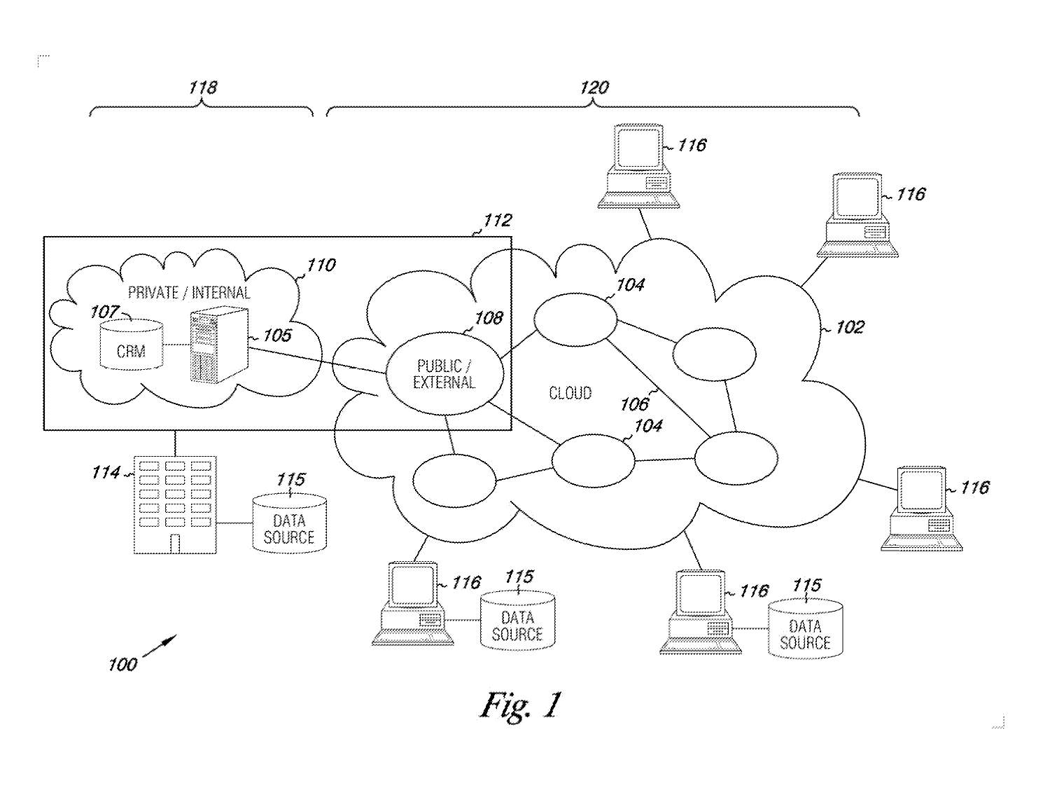

FIG. 1 is a diagram illustrating a computing system according to an example of the present disclosure. The computing system shown in FIG. 1 is a networked computing system, such as a cloud computing system 100. Cloud computing system 100 is one example implementation of a networked computing system. However, examples of the present disclosure are not limited to a particular computing system configuration. By “cloud computing” is meant Internet-based computing that can effectively share physical computing resources, including software and/or information among a number of users. Cloud computing enables fine-grained provisioning of computing resources in real time to achieve dynamic scalability in response to varying data processing levels.

Cloud computing system 100 can include a private cloud 110 communicatively coupled to a public cloud 102. The public cloud 102 can include a number of computing resources 104 networked together by various communication channels 106 including first computing resources 104 external to a hybrid cloud 112 (discussed further below), and second computing resources external to the hybrid cloud 112. The computing resources 104 comprising the public cloud 102 can be of varying size and capability, may be respectively geographically dispersed from one another or be commonly located, and may be respectively owned and/or operated by any number of independent entities. The size, capabilities, and configuration of public cloud 102 can be dynamically changed as dictated by service level agreements, actual computing requirements, and for other factors applicable to cloud computing arrangements.

The term “public” refers to computing resources offered and/or available for use by entities (e.g., the public) other than the computing resource owners, usually in exchange for compensation (e.g., computing capability for hire). Computing resources 104 comprising the public cloud 102 may be owned by discrete entities, which may or may not be participants in a particular collaborative information system for which the computing resources are being employed.

A respective private owner/operator can make owner/operator-maintained computing resources available to the public for hire. The term “private” refers to computing resources dedicated for use by a limited group of users (e.g., one entity such as a company or other organization). That is, “private” is intended to mean reserved for use by some and not available to the public.

The private cloud 110 can be comprised of a number of computing resources 105. While a single server is shown in FIG. 1, the private cloud can be comprised of multiple computing resources 105. A computing resource 105 can include control circuitry such as a processor, a state machine, application specific integrated circuit (ASIC), controller, and/or similar machine. As used herein, the indefinite articles “a” and/or “an” can indicate one or more than one of the named object. Thus, for example, “a processor” can include one processor or more than one processor, such as a parallel processing arrangement. The control circuitry can have a structure that provides a given functionality, and/or execute computer-readable instructions that are stored on a non-transitory computer-readable medium 107. The non-transitory computer-readable medium 107 can be integral, or communicatively coupled, to a computing resource 105, in either in a wired or wireless manner. For example, the non-transitory computer-readable medium 107 can be an internal memory, a portable memory, a portable disk, or a memory located internal to another computing resource (e.g., enabling the computer-readable instructions to be downloaded over the Internet). The non-transitory computer-readable medium can have computer-readable instructions stored thereon that are executed by the control circuitry (e.g., processor) to provide a particular functionality.

The non-transitory computer-readable medium 107, as used herein, can include volatile and/or non-volatile memory. Volatile memory can include memory that depends upon power to store information, such as various types of dynamic random access memory (DRAM), among others. Non-volatile memory can include memory that does not depend upon power to store information. Examples of non-volatile memory can include solid state media such as flash memory, EEPROM, phase change random access memory (PCRAM), among others. The non-transitory computer-readable medium 107 can include optical discs, digital video discs (DVD), high definition digital versatile discs (HD DVD), compact discs (CD), laser discs, and magnetic media such as tape drives, floppy discs, and hard drives, solid state media such as flash memory. EEPROM, phase change random access memory (PCRAM), as well as other types of machine-readable media.

A data source 115 owned by entity 114 (e.g., organization, natural person) can be part of private cloud 110, or as shown in FIG. 1, communicatively coupled to private cloud 110. That is, information under the control of organization 114 may be stored in the computing resources comprising private cloud 110, or be stored in memory accessible by private cloud 110. The data source 115 may be used in a collaborative information system, with organization 114 making some portion of the information stored in data source 115 available to other participants in the collaborative information system, as is further described below.

Although not shown in FIG. 1 for clarity, private cloud 110 can also include a number of computing resources (e.g., physical resources, software, etc.), such as computing resources 104, networked together by various communication channels 106. The computing resources of private cloud 110 can be homogeneous or of varying size and capability, may be geographically dispersed from one another or be commonly located, and may be owned and/or operated by one or any number of independent entities that dedicate some or all of their computing resources for the private use of one entity (e.g., organization 114). The size, capabilities, and configuration of the private cloud can change as dictated by service level agreements, dynamic computing requirements, and other factors applicable to cloud computing arrangements.

A portion 116 of cloud computing system 100 may be owned by organization 114, and another portion 120 of cloud computing system 100 may be owned by entities other than organization 114. As such, in addition to being private, private cloud 110 may be referred to as an internal cloud as well (e.g., a cloud computing arrangement internal to organization 114 and dedicated to the private use of organization 114). Considerations regarding specific cloud computing system configuration may include security, logging, auditing/compliance, firewall boundary location, and/or company policy, among others. Organization 114 may maintain additional computing resources not dedicated to the private use of organization 114 (e.g., available for contract use by the public as part of a cloud).

A number of entities 116 may be users of the public cloud 102 (e.g., as a networked computing system). Some entities 116 may have data sources 115 that may be used in (e.g., made available for query by participants) a collaborative information system, and other entities 116 using the public cloud may participate in the collaborative information system (e.g., invoke queries) but not have, or make available, a data source to other participants. There are many products from a variety of different vendors that can implement data sources that may be used for collaborative information services via standard interfaces for data queries.

While cloud computing system 100 is illustrated in FIG. 1 as two communicatively coupled clouds (e.g., private and public), examples of the present disclosure are not so limited, and the method of the present disclosure can be implemented using a private cloud 110, public cloud 102, or a hybrid cloud 112 comprising some portion of the public cloud 102 and the private cloud 110 made available for such use.

Not all of the components and/or communication channels illustrated in the figures are required to practice the system and method of the present disclosure, and variations in the arrangement, type, and quantities of the components may be made without departing from the spirit or scope of the system and method of the present disclosure. Network components can include personal computers, laptop computers, mobile devices, cellular telephones, personal digital assistants, or the like. Communication channels may be wired or wireless. Computing devices comprising the computing system are capable of connecting to another computing device to send and receive information, including web requests for information from a server. A server may include a server application that is configured to manage various actions, for example, a web-server application that is configured to enable an end-user to interact with the server via the network computing system. A server can include one or more processors, and non-transitory computer-readable media (e.g., memory) storing instructions executable by the one or more processors. That is the executable instructions can be stored in a fixed tangible medium communicatively coupled to the one or more processors. Memory can include RAM, ROM, and/or mass storage devices, such as a hard disk drive, tape drive, optical drive, solid state drive, and/or floppy disk drive.

The non-transitory computer-readable media can be programmed with instructions such as an operating system for controlling the operation of server, and/or applications such as a web page server. The collaborative information services (CIS) platform and/or applications (e.g., services and/or models) may be implemented as one or more executable instructions stored at one or more locations within volatile and/or non-volatile memory. Computing devices comprising the computing system implementing the collaborative information system may also include an internal or external database, or other archive medium for storing, retrieving, organizing, and otherwise managing data sources and/or the functional logic of the collaborative information system.

Computing devices comprising the computing system may also be mobile devices configured as client devices, and include a processor in communication with a non-transitory memory, a power supply, one or more network interfaces, an audio interface, a video interface, a display, a keyboard and/or keypad, and a receiver. Mobile devices may optionally communicate with a base station (not shown), or directly with another network component device. Network interfaces include circuitry for coupling the mobile device to one or more networks, and is constructed for use with one or more communication protocols and technologies. Applications on client devices may include computer executable instructions stored in a non-transient medium which, when executed by a processor, provide such functions as a web browser to enable interaction with other computing devices such as a server, and/or the like.

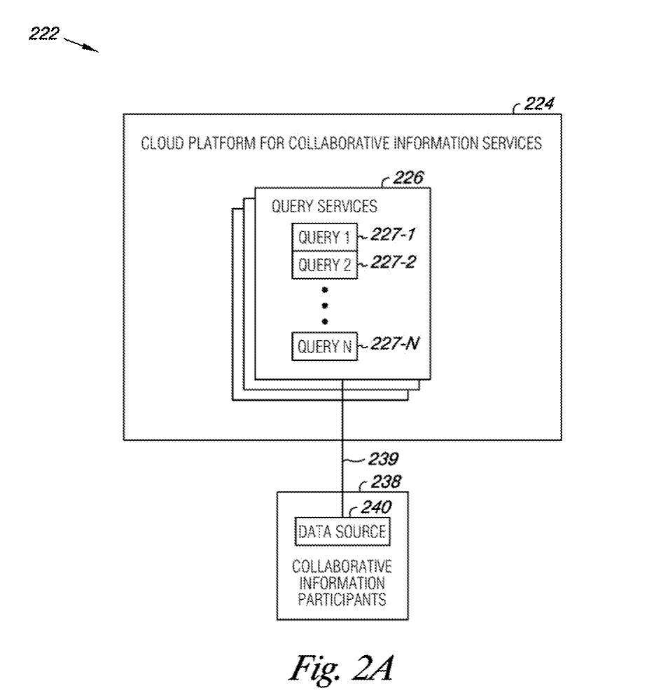

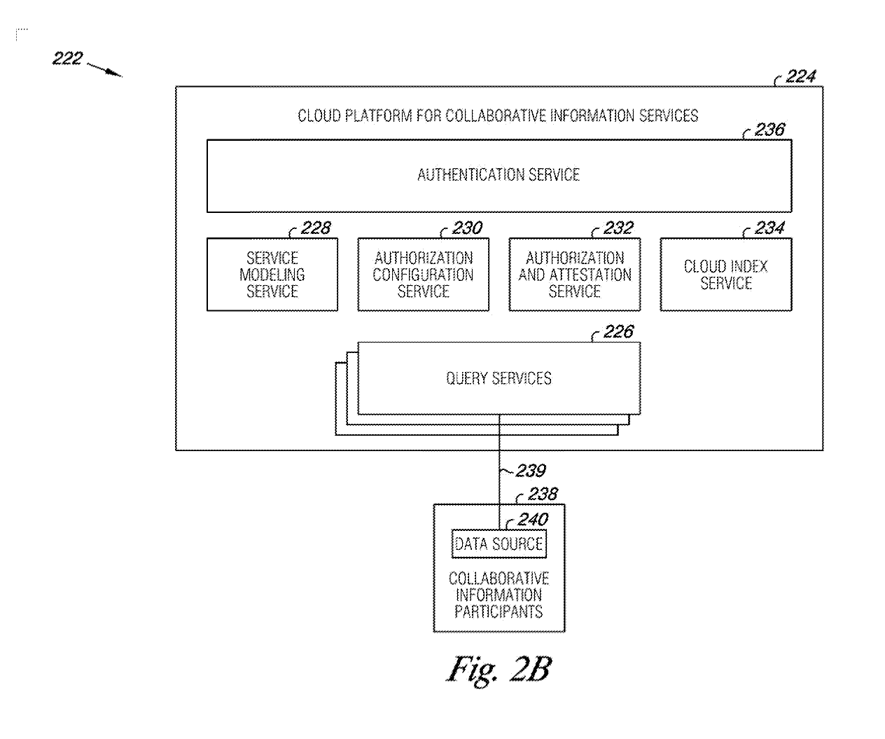

FIG. 2A is a diagram illustrating an example computing platform for providing collaborative information services according to an example of the present disclosure. The systems and methods of the present disclosure for collaborative information services are illustrated throughout this description with respect to a supply chain application of the collaborative information system. However, implementation of the collaborative information system of the present disclosure is not limited to supply chains, and other collaborative information service implementations are contemplated, including SaaS implementations.

A networked computing system implementing collaborative information services (CISs) can be applied to the information associated with a supply chain to provide a secure and trusted registry for supplier and customer information. Such a collaborative information system can act as a cache for information that connects services, partners, and customers. For example, suppliers may register products they sell with the collaborative information system, and customers may register products they use.

The collaborative information system can be used, for example, to provide a recall service upon a product associated with the supply chain. Information in the collaborative information system can cause recall messages to be sent to specific recipients (e.g., existing customers), rather than be broadcast generally (e.g., sent to potential customers as well). Recall messages can include detailed instructions appropriate for a particular recall, or series of recalls. Such a recall service could record the messages sent so that a supplier has the assurance that registered customers are notified.

A customer may also act as a supplier of a product that includes other products as parts. If one of the parts is recalled, then the customer may issue an additional recall via the collaborative information system for the composite product. In this way recall messages can traverse an appropriate portion of the supply chain without being over-, or under-, inclusive.

FIG. 2A illustrates an example architecture of a collaborative information system 222. For example, some, or all, of the participants in the supply chain of interest can be participants 238 in the collaborative information system 222. Collaborative information system participants 238 may have zero or more data sources 240 (e.g., databases, memory) that may be made available to the collaborative information system 222, and other participants 238 therein. Such data sources 240 can be widely deployed, owned and/or controlled by independent entities, and can be implemented with standard interfaces for sharing supply chain information. Some participants 238 of the collaborative information system 222 may not provide a data source to the collaborative information system 222 (e.g., have zero data sources). Some participants 238 of the collaborative information system 222 may participate by invoking query services without offering a data source. For example, regulators or consumers may be collaborative information system participants 238 without also being data source providers.

The collaborative information system 222 illustrated in FIG. 2A includes a CIS platform 224 communicatively coupled to a plurality of collaborative information participants 238 interconnected via a communication network 239, each participant 238 having a data source 240. According to an example embodiment, the collaborative information system 222 can be implemented by a networked computing system such as the cloud computing system 100 illustrated in FIG. 1, with the CIS platform 224 being implemented as a cloud platform. That is, the CIS platform can be implemented using geographically diverse and dynamically-configured computing resources.

The CIS platform 224 is communicatively coupled to the data sources 240 associated with participants in the collaborative information system via communication link 239. The CIS platform 224 is programmed with CISs 226 (e.g., query services). Each query service 226 is implemented using one or more queries (e.g., 227-1, 227-2, . . . 227-N) operable on authorized portions of participant data sources 240. That is, each CIS can be a set of one or more queries involving the available data sources 240. A group of queries may be the same or different (e.g., more or less inclusive) than a query set, which is discussed further below. In other words, each query service may be implemented using a standardized group (e.g., “canned set”) of queries. The CIS platform 224 is further programmed with indications from individual ones of the plurality of collaborative information participants 238 authorizing some portion of their data source 240 to be available to the one or more queries (e.g., 227-1, 227-2, . . . 227-N) defined by at least one query service 226. Participants 238 can make all or part of their data source available to all or part of a respective query, or query set. A participant 238 may require its IT staff to enable a query or query set. However, once enabled, the participant may then authorize additional query services that already have their required queries implemented without further involvement of the IT staff.

FIG. 2B is a diagram illustrating another example computing platform for providing collaborative information services according to an example of the present disclosure. In addition to the query services 226, the CIS platform 224 can be programmed with a service modeling service 228, an authorization configuration service 230, an authorization and attestation service 232, a cloud index service 234, and an authentication service 236.

The service modeling service 228 describes the queries issued by each query service 226, as well as the attributes (e.g., format, scope) of the output results by a respective query service 226. The authorization configuration service 230 is a portal that allows CIS participants to control the access to their data sources by query services 226 and/or individual queries. The authorization portion of the authorization and attestation service 232 ensures that just authorized queries by authorized query services 226 access participant data sources 240. The attestation portion of the authorization and attestation service 232 logs interactions of the various services and the participant's data sources 240, if desired by a participant 238, to serve as an audit trail. The cloud index service 234 maintains a cache of authorized information from data sources 240 that enable the efficient implementation of query services which require information for just a fraction of the potentially large number of data sources 240.

The CIS platform 224 is programmed (e.g., with executable instructions stored in a memory and executable on a processor) to implement the following functionality. Participants 238 in the collaborative information system 222 authenticate with the CIS platform 224 (e.g., peer-to-platform and platform-to-peer, together referred to as peer-to-platform-to-peer) rather than directly with each other (e.g., peer-to-peer). For example, a first participant 238 can authorize the CIS platform 224 to execute certain query services and/or queries on certain portions of the first participant's data sources 240, providing the query results in certain, specified ways (explained further below). The first participant 238 can further authorize the CIS platform 224 to permit certain other participants to invoke the authorized query services (and/or queries) on the authorized portions of the first participant's data sources 240.

Thereafter, another participant 238, if authorized by the platform as a result of the platform being authorized to permit the another participant 238, can cause the CIS platform 224 to invoke an authorized query service 228 (and/or queries). That is, the first participant can authorize a query, a query set, and/or a CIS, to involve portions of the first participant's data sources specified by the first participant corresponding to each query. Subsequently, one or more participant(s), if authorized with respect to the query, or query set and/or a query service, can then execute the query, a query set, and/or a query service, to involve portions of the first participant's data sources that the first participant specified corresponding to a respective query. In this manner, the first participant does not have to individually authorize (and monitor or control) each subsequent participant individually that wishes to execute the query, or query set and/or query service. Provisions are explained below for creating new queries and/or query services (i.e., groups of queries).

The peer-to-platform and platform-to-peer authorization functionality of the CIS platform 224 enables participants 238 to authorize CIS services that access data in standardized (e.g., known) ways instead of having to manage point-to-point data sharing rules among participants that can be typical of previous information sharing approaches. The peer-to-platform and platform-to-peer authorization relationship structure, effectively a hub-and-spokes configuration, enables greater scalability from the perspective of managing the collaborative information system arrangements. The peer-to-platform and platform-to-peer authorization relationship structure, and standardized querying with known query service result attributes, also enables greater data sharing while greatly reducing the risk of data mining by competitors.

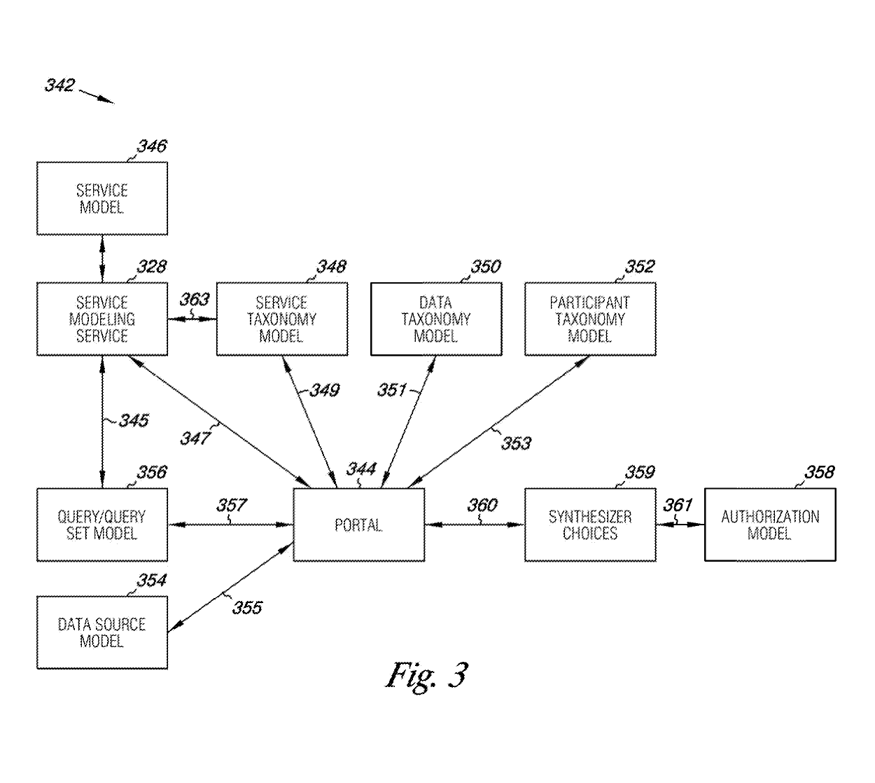

FIG. 3 is a diagram illustrating components of the collaborative information services platform according to an example of the present disclosure. A portal access system 342 includes a portal 344 communicatively coupled to a number of models and services. The portal 344 provides access to collaborative information system models that enable greater self-configuration by participants of the CIS platform (e.g., FIG. 2A at 224). Models refer to logic that may be implemented in hardware or by executable instructions stored in a memory and executable by a processor to perform a function. Participants configure models via the portal 344.

FIG. 3 shows portal 344 providing access to the service modeling service 328 via communication link 347. The service modeling service is communicatively coupled to a service model 346. An authorized service developer can use the portal 344 to manage the lifecycle of a particular service (e.g., a query service that relies on a set of one or more queries). The portal can support both human and programmatic interactions with the same level of functionality that includes the registration, categorization, and description of the service. The description of the service includes a description of the information used by the service (e.g., the queries), and the output provided by the service (e.g., the result attributes).

FIG. 3 shows portal 344 providing access to the service taxonomy model 348 via communication link 349. Participants can use the portal 344 to indicate which services in the service taxonomy model 348 they are willing to support for specific categories of data, and/or for particular locations of their data sources. The service taxonomy model 348 is communicatively coupled to the service modeling service 328 via communication link 363 such that they may exchange information. Services can be categorized to facilitate working with large numbers of services. For example, a participant may authorize a category of services instead of having authorize a quantity of services individually. In addition, services properly added to a prior-authorized category may be authorized by virtue of the proper categorization to the authorized category.

Services can be categorized in hierarchies based on the service taxonomy model 348 that can reflect one or more of type of service, type of result(s), and/or query/queries sets being executed to implement the service. Services can be related to other services, inherently or invoked by a participant in a related fashion (e.g., applying a logical function to the results of queries to arrive at a desired output). For example, a query service “A” may be implemented using queries that are a subset of a query service. As such, query services “A” and B″ are inherently related, with query service “A” being a child of query service “B.” In another example, a participant may wish to interrogate data sources to find an output data set reflecting query service “C” AND query service “D.” In this manner, the participant invokes queries “C” and “D” in a related fashion. In yet another example a second query service may be run in the results of a first query service, such as a downstream consumer service may be run on a service to create an upstream set of data which data providers are willing to share with consumers.

The service taxonomy model 348 can be set up to be static rule based, and/or can include conditional taxonomies. For example, a data provider may be willing to share data for query service “C” run alone. The data provider may also be willing to share data for query service “D” run alone. However, the data provider may feel that the results of query service “C” AND query service “D” reveal too much information regarding the relationship of certain data in the data provider's data source. Therefore, the service taxonomy model 348 can reflect that the results of query service “C” AND query service “D” are not available at all, or that certain portions of the results are summarized to a higher level that is not so revealing, or obfuscated in some manner acceptable to the data provider. Taxonomies concerning related services can also be referred to as conditional taxonomies.

Queries themselves are described in the language(s) supported by data sources. Participants that are data source providers must enable support for such queries for a service to be able to run on their data source. Query sets are sets of queries that are often performed together, and can be authorized subject to use of an appropriate conditional taxonomy. A service (e.g., a query service, discovery service, or other service) can be implemented (e.g. use) using one or more queries, one or more query sets, or portions of one or more query sets. Several different services may have queries that belong to a particular query set. Where a participant authorizes a particular query set to involve portions of the participants data sources, the participant may also authorize any service having queries derived entirely from the authorized particular query set. By authorizing a number of query sets, a participant can choose to authorize a wide range of services derived from the number of query sets implemented to operate on their data sources without having to evaluate (and authorize) the services individually. According to some examples of the present disclosure, a participant having a data source (e.g., data provider) can implement query sets with respect to their data source and use taxonomy model(s) to authorize services using queries of the implemented query sets. According to some examples, a participant may revoke or conditionally modify authorization of certain services despite having authorized a query set that includes each of the queries of the service. An authorization may be conditionally modified using a conditional taxonomy. For example, the relationships between individual services may be obfuscated for the presentation of data for an individual service. Therefore, a combination of two or more services (e.g., by logical operation) may not be possible without additional constraints even if the services are available individually. That is, a “composite” service may have different participation/access rights pursuant to a conditional taxonomy.

FIG. 3 shows portal 344 providing access to the query/query set model 356 via communication link 357. Participants must implement the queries and or query sets that are required for the services they choose to authorize. Implementations for query sets for particular data source products can be made available for download to participants via the Query/Query Set model 356. The query/query set model 356 is communicatively coupled to the service modeling service 328 via communication link 345, for example, to communicate to services authorization of particular queries and/or query sets.

FIG. 3 shows portal 344 providing access to the data source model 354 via communication link 355. Not all data sources will categorize data according to the data taxonomy model 350. The data source model 354 addresses this issue. If a participant's data source labels data according to the taxonomy of the data taxonomy model 350, then queries of a service are constrained based on the taxonomy of the data taxonomy model 350. Otherwise, the query and/or results are further processed to correspond the participant's data source labels to the taxonomy (e.g., according to a default mapping or list).

FIG. 3 shows portal 344 providing access to the participant taxonomy model 352 via communication link 353. The participant taxonomy model 352 defines groups of participants, such as end-consumers, growers, maintenance providers, etc. A participant may be part of zero or more groups as defined in the participant taxonomy model 352. Groups of participants can be used to further govern rights over who is permitted to invoke certain services that involve the participant's own data. That is, a participant may authorize a service to involve their data source except where the service is invoked by a specified other participant, group of participants, and/or or invoked along with (e.g., aggregated with) another service. For example, one service might provide product location information, and another service might provide product count information. A data provider may allow for other participants to run either service individually, but disallow running the two services in aggregate with one another since doing so exposes too much information (e.g., a product count at each location). Or a participant may authorize a service to involve some portion of their data source where the service is invoked by one participant/group, and may authorize a service to involve some other (more or less or different) portion of their data source where the service is invoked by another participant/group.

FIG. 3 shows portal 344 providing access to the data taxonomy model 350 via communication link 351. The data taxonomy model 350 can be configured by a participant to further define a scope of access to the participant's data source with respect to certain categories of the data, which may be further qualified by certain participants. That is a participant may limit some (or all) portions of their data source for a particular service. For example, a participant may limit a service to involve data from their data source that is publically reported, rather than not authorize the service at all. Or a participant my limit the scope of their data source to certain relevant kinds of data for a service invoked by a specified participant, and/or subject to additional constraints with respect to combining (e.g., aggregating) services.

FIG. 3 shows portal 344 providing access to the authorization model 358 via the synthesizer choices 359 and communication links 360 and 361. A participant's configuration of one or more authorizations are synthesized into the authorization model 358, which is used to govern access to the participant's data sources. A participant's authorization configuration specification can also be captured directly into the authorization model 358. The authorization model 358 governs access to the participant's data sources by limiting the access of respective query services by authorized other participants to specified portions of the participant's data sources.

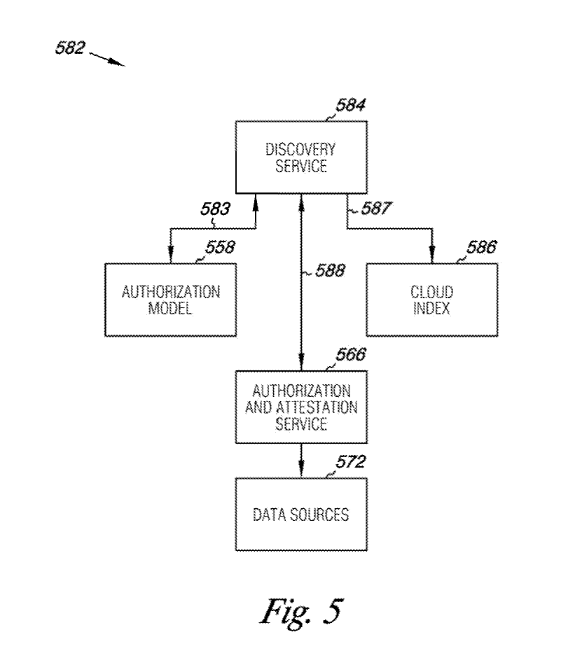

A participant-configured authorization model makes it easier for a participant (e.g., any size organization) to support their own participation in the collaborative information system than was experienced with previous (e.g., peer-to-peer) approaches where more intervention may be needed from IT staff. An example of a service that supports self-configuration for participants and the platform is the discovery service, which is discussed further with respect to FIG. 5. Like other services, the discovery service must be authorized by a participant. Once authorized for execution by the CIS platform, the discovery service peruses the service models of the participant's other authorized services, recognizes the kinds of product category and/or product IDs that are considered in the queries, and then interacts with a participant's data sources to discover which products the participant supports in its supply chain. This information is cached in a cloud index to support the efficient operation of other authorized services. It guides the other authorized query services to participant data sources that are relevant for the query service. Without such a discovery service, participants have to specifically register information they choose to authorize. Thus, self-configuration can benefit both the participant providing a data source, as well as the participant(s) that might wish to invoke services involving the data source that can function more efficiently due to the previous discovery process.

The service developer can describe a service, such as a query service, in the service model 346 using the service modeling service 328. The service developer can configure the service model 346 to indicate the queries and/or query sets that are used by a query service, for example. Participants can access the service model 346 via the portal 344 to learn the queries and/or query sets that are used by a particular query service.

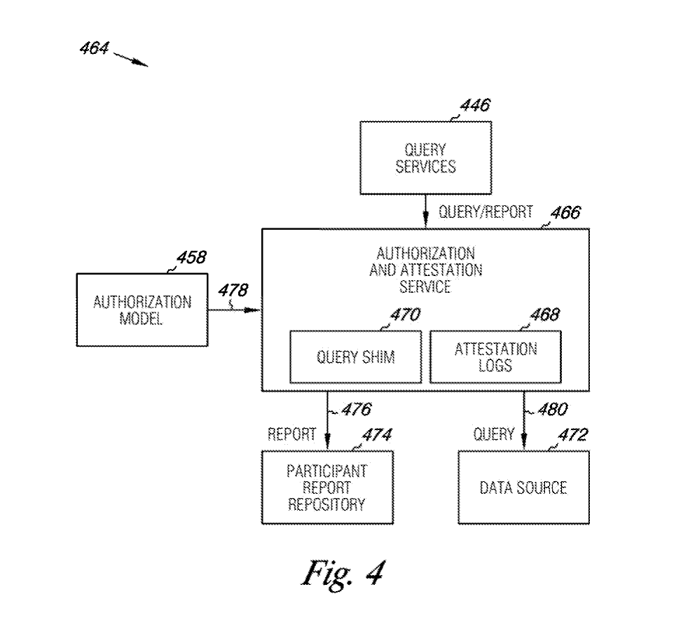

FIG. 4 is a diagram illustrating an authorization and attestation service for a computing platform according to an example of the present disclosure. Authorization logic 464 includes authorization and attestation service 466 having inputs from an authorization model 458 and query services 446, and providing outputs to data sources 472 and a participant report repository 474. The function of the authorization and attestation service 466 is to ensure that the CIS platform (e.g., services such as query services 446) perform authorized queries, for authorized participants, involving authorized data sources, and does not perform unauthorized queries, queries involving unauthorized portions of data sources for a respective query, and/or queries invoked by unauthorized entities (including unauthorized participants).

in addition, another function of the authorization and attestation service 466 is to maintain attestation logs 468 that can be used to audit interactions between participants and the platform and/or data sources. The authorization and attestation service can log queries and/or service invocations, among other activities that may be of interest, and can report results to participants and/or system administrators. According to one example embodiment, reports are stored in a participant report repository 474 via communication link 476.

The authorization and attestation service is guided by the authorization models 458 as may be self-managed by each participant, including service relationship rules expressed in a conditional taxonomy, as previously discussed. The authorization models 458 communicate with the authorization and attestation service 466 via a communication link 478. The authorization and attestation service 466 can include a query shim 470, a “shim” in the sense of being logic that fits between two other logic components so as to relate them (e.g., facilitate communication of useful information therebetween). The query shim 470 is programmed to ensure that just authorized queries are made upon data sources 472 (e.g., via communication link 480), and that just authorized results are returned to the invokers of services. Authorized results may not include raw data from the data sources, or intermediate results (e.g., results computed from the raw data) in response to invoking a service. Authorized results returned to a participant may format, organize, and/or summarize query raw data and/or intermediate results into higher-level authorized results that aggregate the raw data and/or intermediate results in order to maintain confidentiality of individual raw data, according to the service description. In this way, the raw data from a data source and computed intermediate results are not exposed to an invoker of a service unless they are included in the definition of results for a particular service. Thus, a data source provider is always aware of what data will be returned to an invoker of a service and can use the knowledge to direct its own authorization choices.

FIG. 5 is a diagram illustrating an automated data discovery service for a computing platform according to an example of the present disclosure. A discovery service can discover information that enables the efficient execution of the query services. According to example implementations, the discovery service can be a service like any other in the collaborative information services computing platform. The discovery service can be implemented according to the present disclosure so that it does not require an additional set of concepts, tools, or maintenance effort. If desired by a participant, the discovery service can “auto-discover” information based on the participants' already-existing authorization model. This ensures that cached discovered information is consistent with information obtained via query services in accordance with the participant's authorization model.

An automated data discovery service according to the present disclosure can be used to augment participant-invoked query services to provide an updating mechanism that minimizes additional (e.g., manual, peer-to-peer) intervention by a data source controlling entity. Discovery of new data, changed data, relevant query data sources, and/or query results can enable More efficient and scalable execution of supply chain services. However, such advantages can be offset by the burden on participants to enable and manage their support for data discovery over time. Similar to managing participant-invoked query services, it can also be a challenge for participants in a collaborative information system to share discovered information with other participants in a meaningful way without revealing too much information. The data discovery service of the present disclosure addresses these, and other, problems in at least three ways.

First, the discovery service can be managed in a manner similar to other services (e.g., query, services) of the collaborative information system. In this manner, managing the discovery service can be more familiar for participants to work with than a completely separate discovery process, as employed in some previous approaches.

Second, previous information sharing approaches based on point-to-point authorizations, similarly utilized point-to-point authorizations for discovery and sharing of discovered information among participants. The collaborative information system of the present disclosure utilizes peer-to-platform and platform-to-peer authorizations (e.g., a hub and spokes configuration) to minimize the quantity of authorizations applicable to data discovery processes.

Third, some previous point-to-point discovery approaches that are independent from other querying processes were often independently configured (e.g., separately from query service configuring), which can result in configuration difference between query services and discovery services. In contrast, the discovery service of the present disclosure features automatic configuring based on the authorized query services, which minimizes the opportunity for discrepancies between query services and discovery services. As such, the discovery service of the present disclosure can provide architectural, security, and data privacy advantages over previous discovery approaches.

As shown in FIG. 5, discovery logic 582 includes the discovery service 584 communicatively coupled to the authorization model 558 via communication link 583, and communicatively coupled to the authorization and attestation service 566 via communication link 588, and communicatively coupled to an index service 586 (e.g., a cloud index service) via communication link 587. The discovery service 584 communicates with the authorization model 558 to determine what services are authorized by a particular participant. The discovery service 584 then inspects the queries of services authorized by the particular participant, and builds information (e.g., knowledge) regarding the kinds of master and transactional data that may be accessed from a participant's data sources 572.

According to some examples of the present disclosure, master data can concern groups of items (e.g., classifications), whereas transaction data can concern individual items. For example, with respect to a collaborative information service applied in regards to a supply chain, master data might concern attributes corresponding to numerous kinds of stereo equipment, but the discovery service might also discover transactional data such as the actual instances of stereo equipment in the data sources and activities (e.g., sales, fabrication steps, locations, data of manufacture, component types/sources, etc.) involving specific instances of stereo equipment.

The collaborative information system computing platform implements a number of services and models including a service modeling service (e.g., FIG. 3 at 328), a service taxonomy model (e.g., FIG. 3 at 348), a data taxonomy model (e.g., FIG. 3 at 350), a participant taxonomy model (e.g., FIG. 3 at 352), a query/query set model (e.g., FIG. 3 at 356), a data source model (e.g., FIG. 3 at 354), and an authorization model (e.g., FIG. 3 at 358). The various taxonomy models categorize information based on hierarchy, and/or roles. The respective taxonomy models provide a mechanism for a participant to treat groupings of services, data, and/or participants in similar ways, respectively, when creating an authorization model. For example with respect to a collaborative information service applied in regards to a supply chain, services may be associated with a particular industry (e.g., transportation) in a service taxonomy model. Several products may all correspond to a class of products (e.g., stereo equipment) in a data taxonomy model. Several participants may be categorized as suppliers in a supply chain in a participant taxonomy model.

The discovery service 584 is guided by the authorization model and the data taxonomy model, among other models, so the configuration of discovery is familiar and consistent between query and discovery processes. That is, using the authorization model and the data taxonomy model for both the query and discovery processes yields compatible results between the scope of data offered for discovery and the scope of data used by the query services.

If authorized by a participant, the discovery service can periodically discover the results of authorized queries involving authorized portions of a data source and store discovered information in a manner that it is available to queries executed when a query service is invoked. The discovered information can be the actual data results of the query and/or an identification of data sources that contain data pertinent to the query (e.g., such that queries executed from a query service being invoked can be confined to those data sources that are known to contain the data pertinent to the query).

The discovery service 584 can run the queries of services authorized by the particular participant involving the authorized portions of the particular participant's data sources 572 to find out what kinds of corresponding master and transactional data are actually present. As with other services, the queries executed by the discovery service 584 are supervised by the authorization and attestation service 566 to ensure that the collaborative information system computing platform just performs authorized queries for data involving authorized portions of the particular participant's data source(s).

More specifically, once authorized for execution by the computing platform with respect to one or more data sources (e.g., upon indication from one or more participants to involve the respective participant's data source), discovery service 584 periodically peruses the service models of the participant's other authorized services, thereby recognizing the kinds of data IDs that are considered in the queries authorized by the participant involving the respective participant's data source. For example with respect to a collaborative information service applied in regards to a supply chain, the discovery service 584 can discover product category and/or product IDs that are considered in other queries authorized by a respective participant.

The discovery service 584 can then interact with a respective participant's data source(s) to discover which products in the supply chain are related in some way to the product category and/or product IDs that are considered in other queries authorized by the respective participant. The discovered information may include the identity of different product categories, product models, and product instances that appear in the participant's data source. Without such a discovery service, participants would have to, for example, specifically register new information they choose to authorize after it is created in their respective data source(s).

The information that results from the queries executed by the discovery service 584 (e.g., discovered information) can be cached in a collaborative information system index (e.g., a cloud index) 586. The cloud index 586 can be subsequently used directly (e.g., in lieu of searching individual participant data sources) or indirectly (e.g., queries can be confined to those data sources identified as having data pertinent to the query) to support more efficient (e.g., optimized) execution of query services.

For example with respect to a collaborative information service applied in regards to a supply chain, after the discovery service 584 has populated a cloud index 586 with discovered information, a query service of interest can be invoked by a participant to operate with respect to a particular brand of stereo components across a number of data sources. As the query service of interest was defined before being invoked by the participant (e.g., by the service modeling service), the discovery service 584 likely has previously run the queries comprising the query service being invoked and cached the discovered information in the cloud index 586. In response to the query service of interest being invoked by the participant, the queries comprising the query service of interest execute. The executed queries can be directed first towards the cache in an attempt to quickly find either the data sources pertinent to respective queries (and skip searching data sources not identified as being pertinent to the respective query) or recent results of the same query as caused to be executed by the discovery service in order to determine which supply chain participants have the particular brand of stereo components. Directing queries of a query service first towards the cache of discovered information avoids have to query a large quantity of possible data sources in real time in response to invocation of a query service.

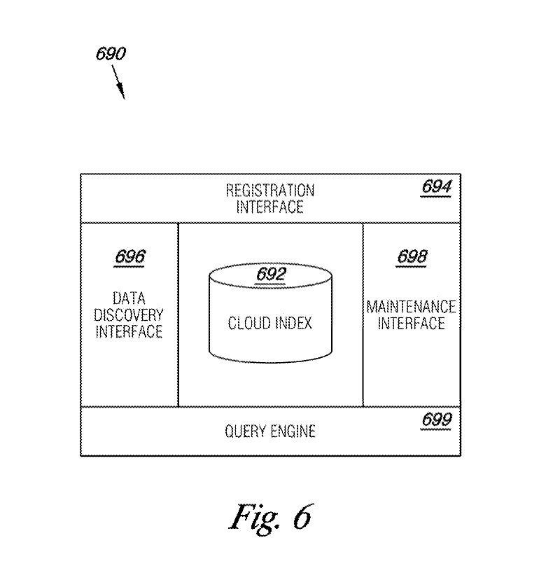

While a single cloud index is indicated in FIG. 5 for clarity, examples of the present disclosure are not so limited. That is, the collaborative information system of the present disclosure can include more than one cloud index, and/or cloud index caching arrangements (e.g., a cloud index and associated interfaces and supporting data processing hardware and/or programmed functionality, as is further discussed with respect to FIG. 6 below).

The discovery service 584 can repeat a discovery process for each respective participant that has authorized the discovery service to be operable upon that participants data source(s). Optimally, the discovery service 584 will be authorized by each participant having a data source (e.g., by a data source controlling entity) in a manner that has discovered information for every query cached in the index and available when a query service is invoked. However, having discovered information for some queries cached in the index will improve the search times of the collaborative information system.

As previously mentioned, the discovery service 584 has to be authorized by a respective participant in order for the discovery service to execute queries that involve the respective participant's data source. After being authorized, the discovery service 584 can be invoked by a participant (e.g., manually invoked) to initiate a discovery process, similar to the way that query services are invoked. Alternatively, or in addition to manual invocation, the discovery service 584 can be invoked to periodically perform the discovery process without further intervention or action by the authorizing participant. That is, a participant does not have to further invoke the discovery service to launch the discovery process. In this manner, the discovery service can continuously operate in the background to obtain discovered information so long as authorized by a participant, or unless otherwise stopped.

As discussed briefly above, the discovery service 584 is a service that supports self-configuration for participants and the computing platform. That is, if the discovery service 584 is not specifically indicated by a particular participant as being authorized, queries executed by the discovery service will not involve the respective participant's data source, just as queries of a query service that has not been authorized by the participant will not involve the respective participant's data source. If the discovery service 584 is indicated by a particular participant as being authorized, queries executed by the discovery service will be executed involving the respective participant's data source.

The discovery service 584 is self-configured in much the same manner as query services are self-configured. A participant providing a data source is a data provider. A data provider controls access to the data provider's respective data source(s) by the particular queries, query sets, and/or query services the data provider authorizes (each query service comprising a group of queries), by the particular portions of their data sources that the data provider authorizes to be involved with respective query services (e.g., by configuring the data taxonomy model), and by the particular other participants allowed to invoke query services on the data provider's data sources (e.g., by configuring the participant taxonomy model), among others. The discovery service 584 is subject to the same taxonomy models that define query service access to a particular data source. As such, by defining the parameters constraining access by query services to the data provider's respective data sources, a data provider is simultaneously defining the parameters constraining access by the discovery service to the data provider's respective data sources. The same modeling services and taxonomy models applied with respect to query services also govern the “rules” for discovery. As such, the data provider may enable the discovery service to just discover information that is of benefit to the query services the data provider has authorized. In this way, when a data provider changes its authorization model, as it applies to query services, the discovery service and cloud index are adapted automatically.

In this way a participant is able to limit the scope of discovery while yet benefitting from having the cloud index automatically updated whenever a data source has new information about products that had not previously been discovered. This is another example of self-management by the platform. With this disclosure, discovery is another collaborative information system service. The scope of discovery can be managed using the Data Taxonomy model. This provides an elegant method for enabling the controlled discovery of a participant's ever evolving product set. Furthermore, authorizations for other participants to use services can also be filtered by the same Data Taxonomy model. Specifying discovery and authorization according to the same model reduces the likelihood of contradictions or errors in the implementation of authorizations.

For example, with respect to a collaborative information service applied in regards to a supply chain, the discovery service of the present disclosure can be of value to the participant because it, subject to constraints placed on the discovery service by the participant, automatically discovers the nature of the participant's engagement in the supply chain. Without a discovery service the participant would have to affirmatively notify the collaborative information services computing platform of new product categories or products as they become supported by the participant. Otherwise, a large quantity of data sources would have to be searched for a complete query response, which would impose a time consuming burden on the participant and would likely result in errors in that some information may be missed (e.g., if the computing platform is not affirmatively notified of data sources pertinent to particular queries, and assuming queries do not search each and every data source, but rather only those data sources known to be pertinent).

According to some example implementations of the collaborative information system of the present disclosure, the discovery service can also be of value to the collaborative information services computing platform because the discovery service enables the computing platform to support the more efficient execution of other query services. For example, with respect to a collaborative information service applied in regards to a supply chain, if a query service aims to notify all participants of a recall for a particular product model, then it can find which participants have information about the product model in the cloud index populated with discovered information by the discovery service. All of the affected participants can then be notified. Without the cloud index, the computing platform would have to interact with all participants responsive to the recall query service invocation, causing more resource usage and a greater burden on participants that might receive messages they are not interested in (not to mention increasing the possibility of “data mining” by insidious competitors).

FIG. 6 is a diagram illustrating a cloud index cache arrangement according to an example of the present disclosure. The cloud index cache arrangement 690 includes a cloud index 692 communicatively coupled to each of a registration interface 694, a data discovery interface 696, a maintenance interface 698, and a query engine 699. The cloud index cache arrangement 690 supports the collaborative information services. As discussed above, the data discovery service (e.g., FIG. 5 at 584) populates the cloud index 692 with discovered information that can be used to optimize the execution of query services, for example, via a data discovery interface 696. The registration interface 694 and maintenance interface 698 may be standardized interfaces for configuring and managing the cloud index 692 respectively. The query engine 699 can be used to execute queries to populate and/or update the cloud index as may be directed by the data discovery service (e.g., FIG. 5 at 584).

A query shim (e.g., FIG. 4 at 470) can also interact with the cloud index 692 to obtain a list of data sources that may have data of interest to a query. The query shim ensures that only those data sources that have authorized the queries for the particular instance of a query service are able to provide data for the query service. Similarly, the query shim may interact with a number of cloud indexes as supported by different instances of the collaborative information services platform.

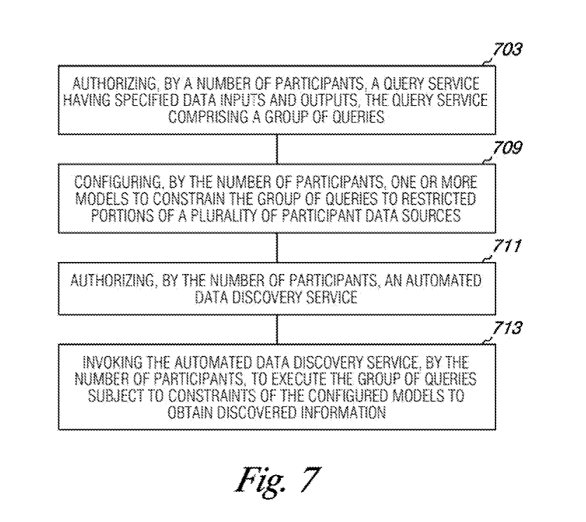

FIG. 7 is a flow chart illustrating an example of a method for an automated data discovery service 701 according to an example of the present disclosure. The method 701 includes authorizing, by a number of participants, a query service having specified data inputs and outputs, the query service comprising a group of queries 703. The method further includes configuring, by the number of participants, one or more models to constrain the group of queries to restricted portions of a plurality of participant data sources 709. The automated data discovery service is authorized by the number of participants 711. The method also includes invoking the automated data discovery service, by the number of participants, to execute the group of queries subject to constraints of the configured models to obtain discovered information 713.

The above specification, examples and data provide a description of the method and applications, and use of the system and method of the present disclosure. Since many examples can be made without departing from the spirit and scope of the system and method of the present disclosure, this specification merely sets forth some of the many possible embodiment configurations and implementations.

Although specific examples have been illustrated and described herein, those of ordinary skill in the art will appreciate that an arrangement calculated to achieve the same results can be substituted for the specific examples shown. This disclosure is intended to cover adaptations or variations of one or more examples of the present disclosure. It is to be understood that the above description has been made in an illustrative fashion, and not a restrictive one. Combination of the above examples, and other examples not specifically described herein will be apparent to those of skill in the art upon reviewing the above description. The scope of the one or more examples of the present disclosure includes other applications in which the above structures and methods are used. Therefore, the scope of one or more examples of the present disclosure should be determined with reference to the appended claims, along with the full range of equivalents to which such claims are entitled.

Various examples of the system and method for collaborative information services have been described in detail with reference to the drawings, where like reference numerals represent like parts and assemblies throughout the several views. Reference to various examples does not limit the scope of the system and method for displaying advertisements, which is limited just by the scope of the claims attached hereto. Additionally, any examples set forth in this specification are not intended to be limiting and merely set forth some of the many possible examples for the claimed system and method for collaborative information services.

Throughout the specification and claims, the meanings identified below do not necessarily limit the terms, but merely provide illustrative examples for the terms. The meaning of “a,” “an,” and “the” includes plural reference, and the meaning of “in” includes “in” and “on.” The phrase “in an embodiment,” as used herein does not necessarily refer to the same embodiment, although it may.

In the foregoing Detailed Description, some features are grouped together in a single embodiment for the purpose of streamlining the disclosure. This method of disclosure is not to be interpreted as reflecting an intention that the disclosed examples of the present disclosure have to use more features than are expressly recited in each claim. Rather, as the following claims reflect, inventive subject matter lies in less than all features of a single disclosed embodiment. Thus, the following claims are hereby incorporated into the Detailed Description, with each claim standing on its own as a separate embodiment.

What is claimed:

1. A method for an automated data discovery service [701] in a collaborative information system [222], comprising:
authorizing, by a number of participants, a query service having specified data inputs and outputs, the query service comprising a group of queries [703];
configuring, by the number of participants, one or more models to constrain the group of queries to restricted portions of a plurality of participant data sources [709];
authorizing, by the number of participants, an automated data discovery service [711]; and
invoking the automated data discovery service, by the number of participants, to execute the group of queries subject to constraints of the configured models to obtain discovered information [713].

2. The method of claim 1, further comprising caching the discovered information in an index [586, 692] of the plurality of participant data sources [240, 572].

3. The method of claim 1, wherein the discovered information is an indication of one or more of the plurality of participant data sources [240] having data results of the group of queries therein.

4. The method of claim 3, further comprising invoking the query service [226, 446], by a particular one of the number of participants [238], to execute the group of queries [227-1, 227-2, . . . , 227-N], wherein each query is respectively constrained to the one or more of the plurality of participant data sources [240, 572] having data results for a particular query therein.

5. The method of claim 3, further comprising re-configuring, by a particular one of the number of participants [238], the one or more models to differently constrain the group of queries [227-1, 227-2, . . . , 227-N] of the query service [226, 446], wherein the automated data discovery service [584] is simultaneously differently constrained according to the re-configured one or more models.

6. The method of claim 1, wherein the invoked automated data discovery service [584] periodically executes the group of queries [227-1, 227-2, . . . , 227-N] with respect to one of the plurality of participant data sources [240, 572], a cached index [586, 692] being updated with the discovered information.

7. A collaborative information system [222], comprising
a plurality of individually-controlled data sources [240, 572] provided by respective data providers [238];
a computing platform [224] communicatively coupled to the plurality of data sources [240, 572], the computing platform [224] programmed with a number of services, including:
query services [226, 446], each query service [226, 446] comprising a group of queries [227-1, 227-2, . . . , 227-N] having predefined data inputs and outputs;
an authorization configuration service [230] to limit the group of queries [227-1, 227-2, . . . , 227-N] of respective query services [226, 446] to corresponding authorized portions of the plurality of data sources [240, 572] as previously indicated to the computing platform [224] by respective data providers [238]; and
an automated data discovery service [584] to periodically execute the group of queries [227-1, 227-2, . . . , 227-N] of respective query services [226, 446] according to the authorization configuration service [230] and cache the discovered information in an index [234, 692].

8. The collaborative information system of claim 7, wherein changes to the authorization configuration service [230] simultaneously limit execution of the group of queries [227-1, 227-2, . . . , 227-N] with respect to respective query services [226, 446] and the automated data discovery service [584].

9. The collaborative information system of claim 7, wherein the discovered information includes the data results of the group of queries [227-1, 227-2, . . . , 227-N] of respective query services [226, 446] involving corresponding authorized portions of the plurality of data sources [240, 572].

10. The collaborative information system of claim 7, wherein the discovered information includes an indication of one or more of the plurality of data sources [240, 572] having data therein that is pertinent to the group of queries [227-1, 227-2, . . . , 227-N] of respective query services [226, 446].

11. The collaborative information system of claim 7, wherein the discovered information includes an indication of one or more of the plurality of data sources [240, 572] having data results of the group of queries [227-1, 227-2, . . . , 227-N] of respective query services [226, 446].

12. The collaborative information system of claim 7, wherein the computing platform [224] is implemented by a cloud computing system 100, and the index is a cloud index [586, 692].

13. A non-transitory computer-readable medium [107] having computer-readable instructions stored thereon that, if executed by one or more processors, cause the one or more processors to:
authorize, by a number of participants, a query service having specified data inputs and outputs, the query service comprising a group of queries [703];
configure, by the number of participants, one or more models to constrain the group of queries to restricted portions of a plurality of communicatively coupled participant data sources [709];
authorize, by the number of participants, an automated data discovery service [711]; and
invoke the automated data discovery service, by the number of participants, to execute the group of queries subject to constraints of the configured models to obtain discovered information [713].

14. A non-transitory computer-readable medium [107] of claim 13, further including computer-readable instructions stored thereon that are executed by the processor to cache the discovered information in an index [586, 692] of the plurality of communicatively coupled participant data sources [240, 572].

15. A non-transitory computer-readable medium [107] of claim 13, further including computer-readable instructions stored thereon that are executed by the processor to re-configure, by a particular one of the number of participants, the one or more models to differently constrain the group of queries [227-1, 227-2, . . . , 227-N] of the query service [226, 446], wherein the automated data discovery service [584] is simultaneously differently constrained according to the re-configured one or more models.
